(19) United States
(12) Patent Application Publication
(10) Pub. No.: US 2013/0020948 A1
(43) Pub. Date: Jan. 24, 2013

(54) AMBIENT LIGHTING CONTROL METHOD AND AMBIENT LIGHTING CONTROL SYSTEM

(71) Applicants: Mi Sook Han, Seoul (KR); Hyun Chul Hwang, Seongnam-si (KR); Seok Hwan Choi, Yongin-si (KR); In Ho Kim, Yongin-si (KR); Mun Sik Kang, Seoul (KR); Joon Seok Lee, Seoul (KR); Hyon Soo Shin, Seoul (KR); Sung Woo Woo, Seoul (KR); Jae Baek Heo, Seoul (KR)

(72) Inventors: Mi Sook Han, Seoul (KR); Hyun Chul Hwang, Seongnam-si (KR); Seok Hwan Choi, Yongin-si (KR); In Ho Kim, Yongin-si (KR); Mun Sik Kang, Seoul (KR); Joon Seok Lee, Seoul (KR); Hyon Soo Shin, Seoul (KR); Sung Woo Woo, Seoul (KR); Jae Baek Heo, Seoul (KR)

(73) Assignee: ECOSUNNY CO., LTD., Seoul (KR)

(21) Appl. No.: 13/636,688

(22) PCT Filed: Mar. 22, 2011
(86) PCT No.: PCT/KR11/01968

§ 371 Date: Sep. 22, 2012

(30) Foreign Application Priority Data
Mar. 22, 2010 (KR) 10-2010-0025080

(51) Int. Cl. H05B 37/02

(52) U.S. Cl. 315/152

(57) ABSTRACT

The present disclosure provides a method of controlling a human-friendly illumination. The method includes determining a displayed object, using a control module, based on at least one data sensed by a sensor module; receiving, by the control module, from a scene database scene data corresponding to the displayed object; creating, by the control module, illumination control information based on the scene data and sending the illumination control information to a lamp control unit; and outputting, by the lamp control unit, an illumination control signal corresponding to the illumination control information to a lamp module.

### CROSS-REFERENCE TO RELATED APPLICATION

This application claims the benefit of Korean Patent Application No. 2010-0025080, filed on Mar. 22, 2010 in the Korean Intellectual Property Office, the disclosure of which is incorporated herein by reference.

### FIELD OF INVENTION

The present application relates to a method and system of controlling a human-friendly illumination.

### BACKGROUND

A human-friendly illumination may be an ambient illumination adapted to be approximate to a natural illumination using an artificial illumination enabled by the human so as to render illumination sophisticated colors or combinations thereof suitable for human feeling. In particular, the human-friendly illumination used herein may intend to include employing all kind of illumination devices with adjustment capability of brightness, color and/or color temperature. For example, a typical example of such an illumination device may a device employing light emitting diodes (hereinafter, LED(s)). The LED illumination device may render various color illuminations using red, blue and green LEDs corresponding to RGB primary colors and/or render various color-temperature illuminations using white LED.

As a variety of human-friendly illumination devices with lower power consumption and easy control of brightness and/or color of light has been developed recently, there is increase of demand for an illumination system in which, in addition to a conventional illumination to make dark environment bright in a given level, illuminations are rendered to be adapted to various human-feelings and are managed in an efficient manner.

### SUMMARY OF INVENTION

Embodiments of the present disclosure provide a method and system of controlling a human-friendly illumination.

In accordance with a first aspect of the present disclosure, there is provided a method of controlling a human-friendly illumination, comprising: determining a displayed object, using a control module, based on at least one data sensed by a sensor module; receiving, by the control module, from a scene database scene data corresponding to the displayed object; creating, by the control module, illumination control information based on the scene data and sending the illumination control information to a lamp control unit; and outputting, by the lamp control unit, an illumination control signal corresponding to the illumination control information to a lamp module.

In accordance with a second aspect of the present disclosure, there is provided a method of controlling a human-friendly illumination, comprising: receiving, by a control module, a displayed object input via a user interface; retrieving, by the control module, from a scene database scene data corresponding to the displayed object and receiving the retrieved scene data from the database; creating, by the control module, illumination control information based on the scene data and sending the illumination control information to a lamp control unit; and outputting, by the lamp control unit, an illumination control signal corresponding to the illumination control information to a lamp module.

In accordance with a third aspect of the present disclosure, there is provided a system of controlling a human-friendly illumination, comprising: a lamp module comprising at least one light emitting device; a lamp control unit to control the lamp module; a scene database including at least one scene data; and a control module configured to retrieve from the scene database scene data corresponding to a displayed object and receive the retrieved scene data from the database, and create information to control a luminance of the lamp module based on the scene data and send the information to the lamp control unit.

In accordance with the present disclosure may have following advantages. It should be appreciated that the present disclosure may have not only following advantages but also other advantages and thus a scope of the present disclosure may not limited to the following advantages.

In accordance with the human-friendly illumination control system of the present disclosure, consumer desire for the displayed product may increase. Moreover, since the brightness, color and color temperature for illumination may be automatically set to enable the displayed object to stand out clearly, the user may conveniently set and/or change illuminations so as to be suitable for the displayed object. Where the displayed object changes, the human-friendly illumination control system may automatically modify the brightness, color and color temperature for illumination. Further, where an ambient environment changes, the human-friendly illumination control system may sense such a change accurately and accordingly modify the brightness, color and color temperature for illumination to be adapted to the changed ambient environment. These modifications may lead to further increase of consumer desire for the displayed product.

In accordance with the human-friendly illumination control system of the present disclosure, the power consumption for illumination may reduce. The illumination may be set in accordance with the target power consumption. The user may conveniently monitor the power consumption and/or illumination state, resulting in convenient management of the illumination system.

### BRIEF DESCRIPTION OF THE DRAWINGS

These and/or other aspects of the invention will become apparent and more readily appreciated from the following description of the embodiments, taken in conjunction with the accompanying drawings of which:

FIG. 1 illustrates an exemplary application of a system of controlling a human-friendly illumination in accordance with one exemplary embodiment of the present disclosure;

FIG. 2 is an exemplary block diagram of a system of controlling a human-friendly illumination in accordance with one exemplary embodiment of the present disclosure;

FIG. 3 illustrates a scene database of FIG. 1;

FIG. 4 illustrates a method of generating the scene database of FIG. 3;

FIG. 5 is an exemplary block diagram of a control module of FIG. 1 in accordance with one exemplary embodiment of the present disclosure;

FIG. 6 illustrates a user interface of a central control unit;

FIG. 7 is a flow chart illustrating a method of controlling a human-friendly illumination in accordance with one exemplary embodiment of the present disclosure;

FIG. 8 is a flow chart illustrating a method of changing a brightness of scene data in accordance with one exemplary embodiment of the present disclosure;

FIG. 9 is a flow chart illustrating a method of automatically updating illuminations based on changes of displayed objects in accordance with one exemplary embodiment of the present disclosure;

FIG. 10 is a flow chart illustrating a method of automatically changing illuminations based on illumination environments in accordance with one exemplary embodiment of the present disclosure;

FIG. 11 is a flow chart illustrating a method of correcting illumination control information based on feedback sensed data in accordance with one exemplary embodiment of the present disclosure; and

FIG. 12 illustrates an exemplary application of the method of correcting illumination control information in FIG. 11.

### DETAILED DESCRIPTIONS OF EMBODIMENTS

These detailed descriptions may include exemplary embodiments in an example manner with respect to structures and/or functions and thus a scope of the present disclosure should not be construed to be limited to such embodiments. In other words, the present disclosure may be embodied in many different forms and should not be construed as limited to the embodiments set forth herein. Rather, these embodiments are provided so that this disclosure will be thorough and complete, and will fully convey the scope of the disclosure to those skilled in the art. The present disclosure is defined only by the categories of the claims, and a scope of the present disclosure may include all equivalents to embody a spirit and idea of the present disclosure.

The terminology used in the present disclosure is for the purpose of describing particular embodiments only and is not intended to limit the disclosure. For example, the terminology used in the present disclosure may be construed as follows.

When one element is “coupled” or “connected” to the other element, this may include a direct connection or coupling between them or an indirect connection or coupling between them via an intermediate element(s). However, when one element is “directly coupled” or “directly connected” to the other element, this means exclusion of the intermediate element. These may be similarly applied to other expressions for relationships between elements, “adjacent to” or “directly adjacent to”; “between” or “directly between”, etc.

As used in the disclosure and the appended claims, the singular forms “a”, “an” and “the” are intended to include the plural forms as well, unless context clearly indicates otherwise. It will be further understood that the terms “comprise” and/or “comprising and/or “include” and/or “including” and/or “have” and/or “having”” when used in this specification, specify the presence of stated features, integers, steps, operations, elements, and/or components, but do not preclude the presence or addition of one or more other features, integers, steps, operations, elements, components, and/or groups thereof.

Steps or operations, unless otherwise specified, may occur in a different order from a designated order. For example, steps or operations may occur in the same order as the designated order, may occur at the same time, or may occur in an inverse order with respect to the designated order.

Unless otherwise defined, all terms (including technical and scientific terms) used herein have the same meaning as commonly understood by one of ordinary skill in the art. It will be further understood that terms, such as those defined in commonly used dictionaries, should be interpreted as having a meaning that is consistent with their meaning in the context of the relevant art and the present disclosure, and will not be interpreted in an idealized or overly formal sense unless expressly so defined herein.

Reference throughout the specification to “one embodiment” or “an embodiment” means that a particular feature, structure, or characteristic described in connection with an embodiment is included in at least one embodiment of the subject matter disclosed. Thus, the appearance of the phrases “in one embodiment” or “in an embodiment” in various places throughout the specification is not necessarily referring to the same embodiment. Further, the particular features, structures or characteristics may be combined in any suitable manner in one or more embodiments.

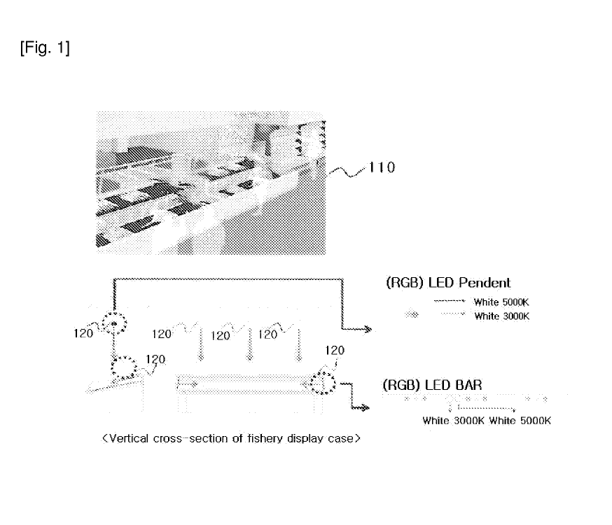

FIG. 1 illustrates an exemplary application of a system of controlling a human-friendly illumination in accordance with one exemplary embodiment of the present disclosure. The system of controlling a human-friendly illumination in accordance with this exemplary embodiment may change brightness, color and/or color temperature thereof based on a type of displayed objects. As one example, such changes of the brightness, color and/or color temperature may be performed to allow the unique color of the displayed objects to stand out clearly, thereby increase of consumer buying desire of the objects.

In one example application of FIG. 1, where the system of controlling a human-friendly illumination is applied to a fishery section of large scale shopping mall, illumination devices 120 may render various colors or brightness and/or color temperatures based on kinds of the displayed objects, for example, based on the unique colors of the displayed fishes. Thus, such illuminations may be adapted to have colors or brightness and/or color temperatures to allow the unique color of the displayed objects to stand out clearly. As one example, in case of food being displayed, colors or brightness and/or color temperatures of illumination devices 120 may be set such that the unique color of the displayed food may be rendered and thus the displayed food may look vividly and freshly.

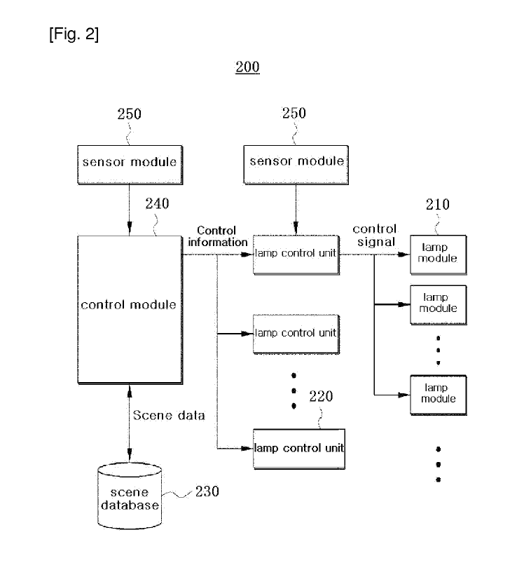

FIG. 2 is an exemplary block diagram of a system of controlling a human-friendly illumination in accordance with one exemplary embodiment of the present disclosure. A human-friendly illumination control system 200 may include a lamp module 210, a lamp control unit 220, a scene database 230 and a control module 240.

The lamp module 210 may include at least one light emitting device (lamp). The lamp may in an example manner include a fluorescent lamp, a halogen lamp, a LED lamp, or the like. Among these lamps, the LED lamp has been increasingly used due to easy control of brightness and/or color, lower power consumption, and/or long life span. Depending on implementations, the lamp module 210 may be formed of a single lamp or multiple lamps. In case of multiple-lamps implementation, the lamps may be disposed to be adjacent to one another in a single space or each of the lamps may be disposed in each of the installation spaces being spaced from each other.

In one example, each of the illumination devices 120 of FIG. 1 may form an individual lamp module 210. In this case, each of the lamp modules 210 may be formed with multiple lamps as in FIG. 1 or may be formed with a single lamp unlike FIG. 1. Alternatively, the plurality of illumination devices 120 of FIG. 1 may be formed into a single lamp module 210. Alternatively, a single illumination device 120 of FIG. 1 may be formed with a plurality of lamp modules 210.

The lamp control unit 220 may control a luminance of the lamp module 210. In one embodiment, the lamp control unit 220 may convert control information received from the control module 240 to an illumination control signal and provide individual lamps of the lamp modules 210 with the converted signal. For example, the control information may be luminance values of individual lamps of the lamp module 210 and/or may be a pulse width modulation (PWM) signal. When the lamp control unit 220 changes the luminance values of the individual lamps of the lamp module 210, the color, brightness and/or color temperature of the lamp module 210 may vary accordingly. For example, a desired color may be rendered by adjusting a luminance of each of red, blue and green LEDs or a desired color temperature may be rendered by adjusting a luminance of each of white LEDs with different color temperatures.

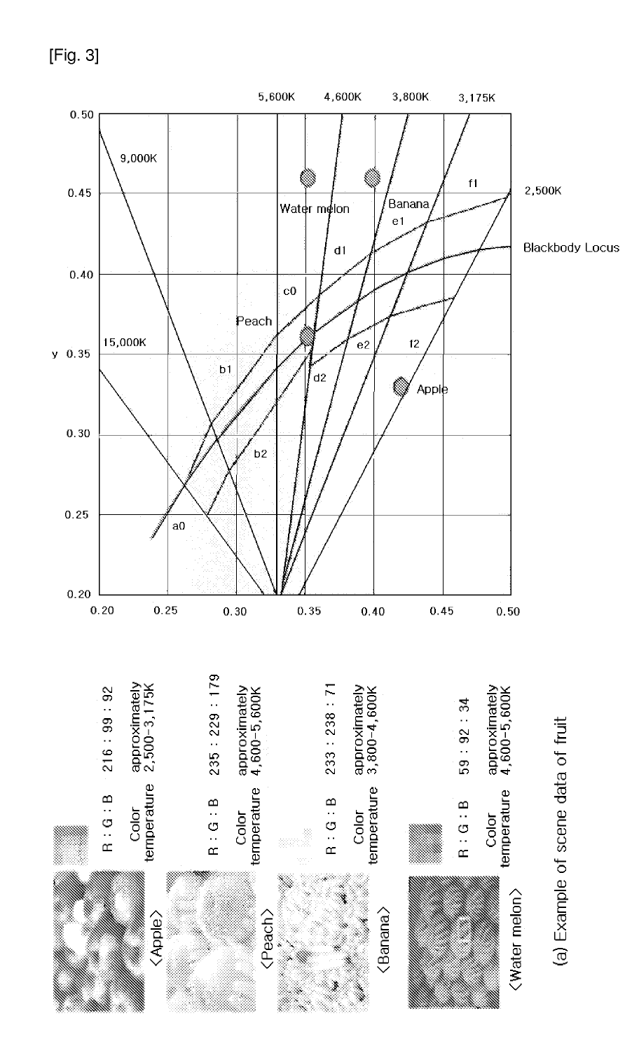

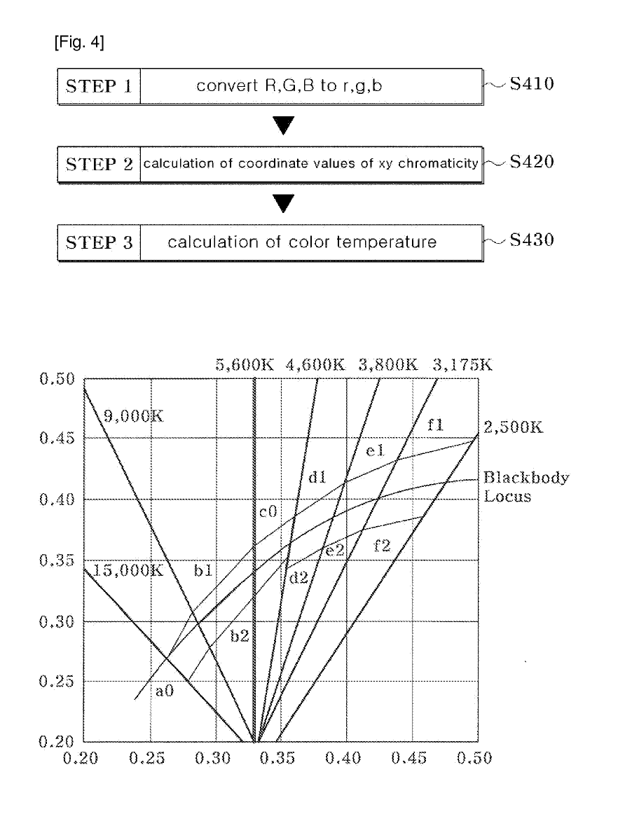

The scene database 230 may include at least one scene data. The scene data may include color, brightness and/or color temperature of the lighting mapped with the displayed objects or products. Generation of the scene data will be described later with reference to FIG. 3 and FIG. 4.

The control module 240 may retrieve the scene data corresponding to the displayed objects from the scene database 230 and receive the retrieved data from the database 230. Information about the displayed objects may be input by the user or may be determined in an automatic manner without intervention of the user.

In one embodiment, the user may input the Information about the displayed objects into the control module 240 via a user interface. When receiving the Information about the displayed objects, the control module 240 may retrieve the scene data corresponding to the displayed objects from the scene database 230 and receive the retrieved data from the database 230.

In one embodiment, the control module 240 may determine the displayed objects in an automatic manner without intervention of the user. As one example, the human-friendly illumination control system 200 may further include a sensor module 250 to sense one or more of brightness, luminance, color, temperature and humidity. The control module 240 may determine the displayed object by retrieving from a display object list an object corresponding to the sensed data obtained by the sensor module 250. The sensor module 250 may be disposed adjacent to the lamp module 210 and send the sensed data to the lamp control unit 220 and/or the control module 240. The display object list may include a list in which the sensed data including the brightness, luminance, color, temperature and humidity, etc of the display environment are mapped with the corresponding displayed objects or products. For example, the details on the temperature, humidity, color and/or brightness of the display environment may be different from each other among apple, chicken and mackerel, and, hence, the temperature, humidity, color and/or brightness data thereof may be mapped with the corresponding products, namely, the apple, chicken and mackerel respectively. On automatic determination of the displayed object based on sensed data, the scene data corresponding to the determined object may be selected from the scene database 230 and then supplied to the control module.

The control module 240 may send control information of the lamp module 210 to the lamp control unit 220 based on the supplied scene data. In one example, where the lamp module 210 is formed of RGB LEDs, the control module 240 may calculate a luminance of each of the red, blue and green LEDs to render color set on the scene data and then may send control information including the calculated luminance to the lamp control unit 220.

The control module 240 may be connected to the lamp control unit 220 in a wire or wireless manner. In one embodiment, the control module 240 may be connected to the lamp control unit 220 in a local wireless communication manner to send the control information thereto. In one example, the control module 240 may include a Zigbee communication module and thus may send the control information to the lamp control unit 220 in a Zigbee communication manner. Such Zigbee communication has advantageously excellent efficiency in terms of cost, power, size, data communication availability, etc. Further, the Zigbee communication may remove need for a wire between the control module 240 and lamp control unit 220, thereby increasing freedom of an installation location thereof in a communication region.

In one embodiment, the control module 240 may include a user interface such as a display device to monitor power consumption of the lamp module 210. The lamp control unit 220 may measure power consumption of the lamp module 210 connected thereto and may send the measured power consumption to the control module 240. The control module 240 may display the measured power consumption on the display device to allow the user to easily check the power consumption of the lamp module 210. Further, the user may directly establish a power consumption plan based on the checking of the power consumption, for example, may set a target power consumption of each of the lamp modules 210 or a collection of the lamp modules 210.

FIG. 3 illustrates a scene database of FIG. 1. FIG. 3a illustrates scene data where the displayed objects belong to fruits. Specifically, where the displayed products are an apple, peach, banana and water melon respectively, there is stored the database 230 in which the apple, peach, banana and water melon are mapped respectively with color temperatures suitable for illumination thereof.

In one embodiment, FIG. 3b is a graph for calculating the color temperatures depending on the displayed objects. Specifically, each of x and y values may be calculated based on R, G, and B values of the unique color of the apple, peach, banana and water melon and then the appropriate color temperature ranges thereof may be calculated based on the locations at which the x and y values are positioned in a xy chromaticity coordinates. The method of determining the scene data depending on the displayed objects is not limited to the above mentioned method.

FIG. 4 illustrates a method of generating the scene database of FIG. 3. First, R, G and B values are extracted from the unique color of each of the displayed objects. With considering each of the R, G and B values as a unit vector, r, g and b values are obtained in accordance with a following equation 1 at a step (S410):

r=R/(R+G+B); g=G/(R+G+B); and b=B/(R+G+B) Equation 1.

Using the obtained r, g, b values, coordinate values of xy chromaticity are calculated at a step (S420). Here, the coordinate values of xy chromaticity may be calculated in accordance with a following equation 2:

x=(0.49000r+0.31000g+0.20000b)/(0.66697r+1.13240g+1.20063b) y=(0.17697r+0.81240g+0.01063b)/(0.66697r+1.13240g+1.20063b) Equation 2.

After calculating the coordinate values of xy chromaticity, the appropriate color temperature ranges may be calculated based on the locations at which the x and y values are positioned in the xy chromaticity coordinates of FIG. 4 at a step (S430).

In one embodiment, the scene database 230 may be created using eXtensible Markup Language (XML). This is advantageously easier to edit than in case of using a machine language.

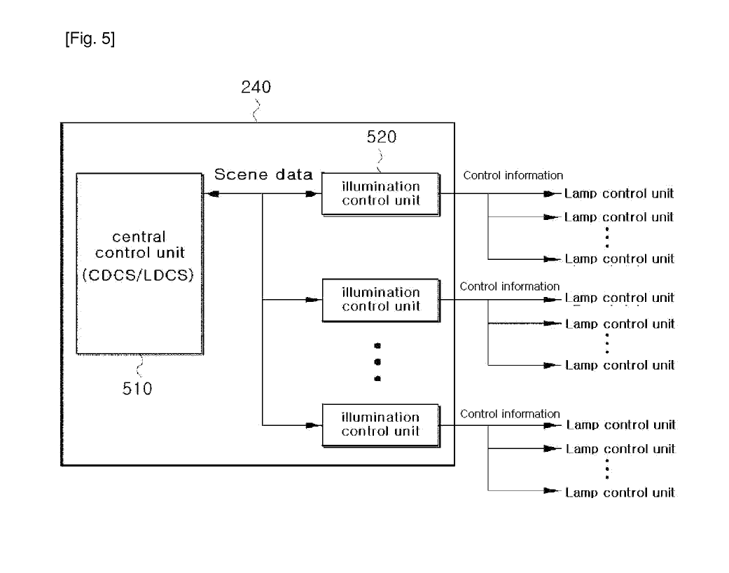

FIG. 5 is an exemplary block diagram of a control module of FIG. 1 in accordance with one exemplary embodiment of the present disclosure. Referring to FIG. 5, in one embodiment, the control module 240 may include a central control unit 510 and at least one illumination control unit 520.

The central control unit 510 may retrieve from the scene database 230 the scene date corresponding to the displayed object and receive the retrieved scene data from the database 230. The illumination control unit 520 may receive the scene data from the central control unit 510 and create control information based on the scene data and in turn send the same to the lamp control unit 220. The central control unit 510 may be connected to the illumination control unit 520 in a wire or wireless manner to send the scene data to the illumination control unit 520. In one embodiment, the central control unit 510 may be connected to the illumination control unit 520 over a wire/wireless communication network including Ethernet. In this case, the central control unit 510 may be connected to a plurality of the illumination control units 520 over the wire/wireless communication network, and thus, each of the plurality of the illumination control units 520 may control a plurality of the illumination modules 210. In this way, the user may advantageously and easily control and manage illuminations of an entirety of a building, an entirety of one floor and/or a plurality of sectors or stores via the single central control unit 510. In one embodiment, the central control unit 510 may be connected to the illumination control unit 520 via an input/output interface including a Universal Serial Bus (USB). In this case, there is no need to establish a separate communication network and the central control unit 510 and/or illumination control unit 520 may be implemented in a portable storage medium (for example, an external hard disk, USB memory stick, etc).

In one embodiment, the central control unit 510 and/or illumination control unit 520 may include a user interface used for a user to input information of the displayed objects. Where the information of the displayed objects is input via the user interface included in the illumination control unit 520, the illumination control unit 520 may send the information of the displayed objects to the central control unit 510.

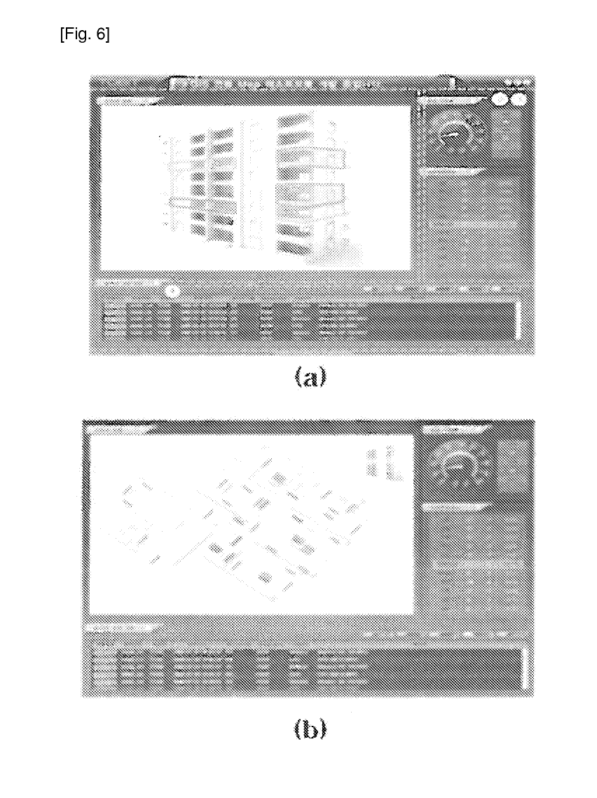

FIG. 6 illustrates a user interface of the central control unit. To be specific, FIG. 6a illustrates a user interface of the central control unit 510 where an entirety of a building (for example, a department store, large scale shopping mall, etc) is controlled by a single human-friendly illumination control system 200. FIG. 6b illustrates a user interface of the central control unit 510 where an entirety of one floor is controlled by a single human-friendly illumination control system 200. In case of FIG. 6a, the user may control and/or monitor an entirety of the building and/or further select floors or sectors or stores to be controlled via the interface of FIG. 6a and control and/or monitor the same. In case of FIG. 6b, the user may control and/or monitor an entirety of one floor or an individual sector.

In one embodiment, the central control unit 510 may monitor a state of each of the illumination modules 210 of the human-friendly illumination control system 200 via the interface of FIG. 6. The state of the illumination modules 210 to be monitored may include failure information, a normal connection state information, and power consumption information, etc of the illumination modules.

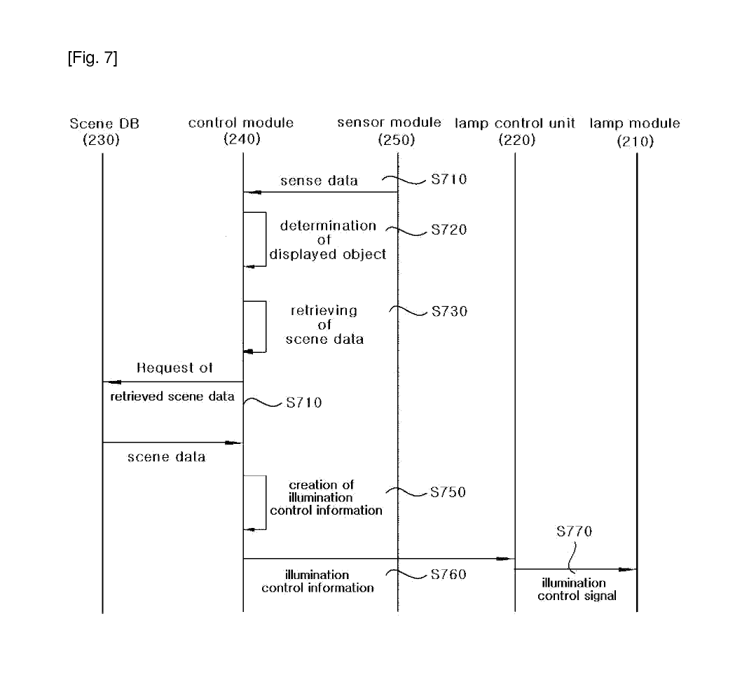

FIG. 7 is a flow chart illustrating a method of controlling a human-friendly illumination in accordance with one exemplary embodiment of the present disclosure. This human-friendly illumination control method will be described with reference to FIG. 2 and FIG. 5. Moreover, this embodiment may correspond to a chronological implementation of the human-friendly illumination control system 200 of FIG. 2. Thus, the descriptions in connection to FIG. 2 may be per se applied to this embodiment.

At a step (S710), the sensor module 250 may sense at least one of a luminance, brightness, color, temperature and humidity and send the sensed result to the control module 240. Next, at a step (S720), the control module 240 may determine the displayed product or object based on the sense result or data. In one example, the control module 240 may determine the displayed object by retrieving from the display object list an object corresponding to the sensed data obtained by the sensor module 250.

In an alternative embodiment, unlike the steps (S710 and S720), the displayed object may be directly input to the control module 240 via the user interface by the user.

At a step (S730), the control module 240 may retrieve from the scene database 230 a scene data corresponding to the displayed object. Next, the retrieved data may be sent from the scene database 230 to the control module 240 at a step (S740). The scene data may include color, brightness and/or color temperature of the lighting mapped with the displayed objects or products.

At a step (S750), the control module 240 may create illumination control information based on the sent scene data. For example, the control module may calculate a luminance of each lamp of the lamp module 210 to render color, brightness and/or color temperature set on the scene data, thereby generating the control information including the calculated luminance.

At a step (S760), the control module 240 may provide the lamp control unit 220 with the created illumination control information.

At a step (S770), the lamp control unit 220 may output an illumination control signal corresponding to the illumination control information to the lamp module 210. For example, the illumination control signal may be a PWM (pulse width modulation) signal.

Optionally, in one embodiment, the sent scene data may be modified. In one example, the control module may modify the color, brightness and/or color temperature of the scene data in accordance with information input via the user interface and/or may update the scene database based on the modified scene data. When the scene data is modified, the illumination control information may be created based on the modified scene data at a step (S750).

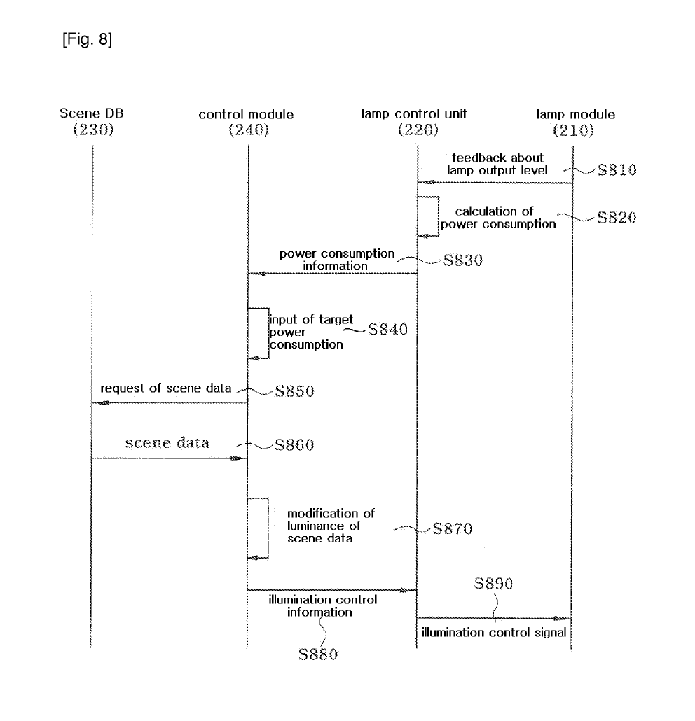

In one embodiment, the control module 240 may change a brightness of the scene data such that a power consumption of the lamp module 210 is equal to a target power consumption input via a user interface. FIG. 8 is a flow chart illustrating a method of changing a brightness of scene data in accordance with one exemplary embodiment of the present disclosure. In one example, the lamp control unit 220 may receive a feedback from the lamp module 210 about a value which each of the lamp of the lamp module 210 outputs based on the real scene data (S810). At a step (S820), the power consumption of the lamp module 210 may be calculated based on the feedback. In one example, unlike FIG. 8, the lamp control unit 220 may estimate a real power consumption of the lamp module 210 by calculating power consumption corresponding to the brightness of the scene data based on a standard of the connected lamp module.

At a step (S830), the calculated power consumption is sent to the control module 240. Meantime, at a step (S840), the user may input the target power consumption via the user interface of the control module 240. It may be obvious to the skilled person to the art that the target power consumption may be input to the control module 240 any time. At a step (S850), the control module 240 may request the scene data corresponding to the displayed object from the scene database 230. At a step (S860), the requested scene data may be sent to the control module 240. Where the control module 240 has the valid scene data previously sent thereto, the steps (S850 and S860) may be omitted. At a step (S870), the control module 240 may change a brightness of the scene data such that the power consumption of the lamp module 210 is equal to the target power consumption input via the user interface. For example, if the calculated real power consumption is larger than the target power consumption, the control module 240 may reduce a luminance of an entirety of the lamp module 210 of the scene data.

The control module 240 may modify the illumination control information in accordance with the changed scene data and send the modified illumination control information to the lamp control unit 220 (S880). The lamp control unit 220 may receive the modified illumination control information and thus modify the illumination control signal based on the modified illumination control information and then send the same to the lamp module 210 (S890).

Since the illumination control system 200 may adjust the brightness of the scene data in accordance with the target power consumption input by the user, this may achieve a convenient adjustment of the total power consumption of the lamp module 210. Thus, the power may be consumed in accordance with a power consumption plan. Further, since the illumination control system 200 may receive a feedback about the real power consumption of the lamp module 210 and/or monitor the same via the user interface, the user may set the target power consumption based on the feedback about the real power consumption. In this way, the user may more efficiently manage the power consumption and thus save the power consumption.

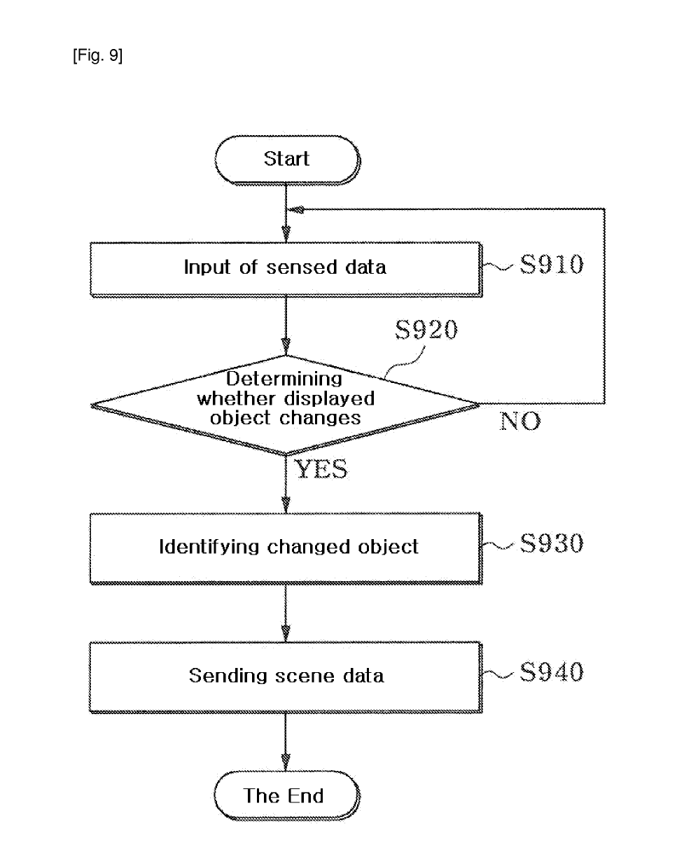

FIG. 9 is a flow chart illustrating a method of automatically updating illuminations based on changes of displayed objects in accordance with one exemplary embodiment of the present disclosure. In accordance with this embodiment, where the color, brightness and/or color temperature of the lamp module is set in accordance with the displayed object using the method of FIG. 7, and, thereafter, the displayed object changes, information of the color, brightness and/or color temperature of the lamp module may be automatically updated in accordance with the changed displayed object.

To this end, the sensor module 250 may sense at least one of a luminance, brightness, color, temperature and humidity to obtain sensed data and send the sensed data to the control module 240 (S910).

At a step (S920), the control module 240 may determine whether the displayed object changes or not based on the sensed data received from the sensor module 250. In one embodiment, the control module 240 may determine that the displayed object changes if the sensed data changes by a variation above a predetermined threshold value.

On determination that the displayed object changes, the control module 240 may identify the changed displayed object at a step (S930). For example, as in the step (S720), the control module may identify the changed displayed object based on the changed sensed data. The control module 240 may receive from the scene database 230 new scene data corresponding to the changed displayed object, and updating the scene data based on the new scene data (S940).

Then, as in the steps (S750 and S760), the control module 240 may update the illumination control information based on the updated scene data and send the updated illumination control information to the lamp control unit 220. Next, as in the step (S770), the lamp control unit 220 may output an illumination control signal corresponding to the updated illumination control information to the lamp module 210.

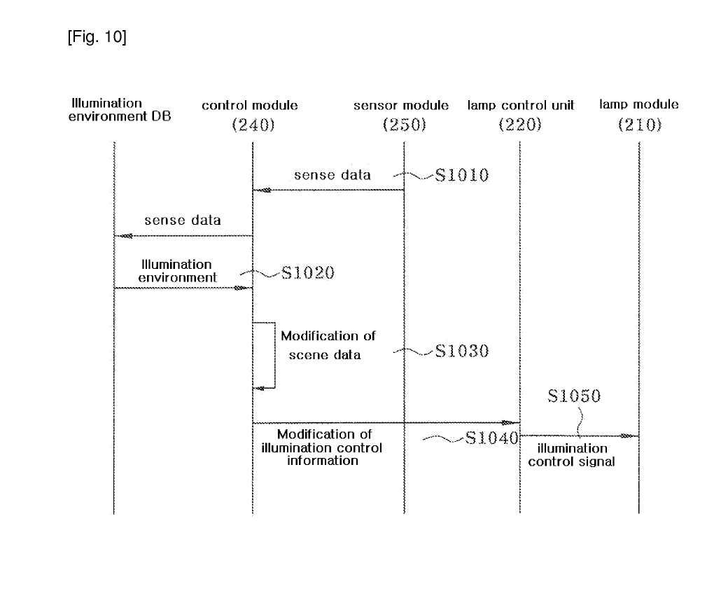

FIG. 10 is a flow chart illustrating a method of automatically changing illuminations based on illumination environments in accordance with one exemplary embodiment of the present disclosure. In this connection, while the illumination may be set to comply with the displayed object, the scene data may be further modified based on ambient illumination environments, thereby achievement of more sophisticated human-friendly illumination control.

To this end, the sensor module 250 may sense at least one of a luminance, brightness, color, temperature and humidity of ambient illumination environments to obtain sensed data and send the sensed data to the control module 240 (S1010).

At a step (S1020), the control module 240 may determine the illumination environment corresponding to the sensed data from an illumination environment list. For example, the illumination environment may be weather, season, time or the like, and the illumination environment list may have a mapping in which at least one sensed data including the luminance, brightness, color, temperature and humidity is mapped with the corresponding illumination environment. For example, the illumination environment list may be created based on a statistics of the luminance, brightness, color, temperature and humidity corresponding to the weather, season, time or the like.

At a step S1030, the control module 240 may modify the scene data based on the determined illumination environment. For example, when it rains or is cloudy, the brightness and/or color temperature for illumination may be modified to be higher so as to stimulate or enhance consumer buying desire which may be otherwise lowered in a rainy or cloudy day.

Then, the control module 240 may modify the illumination control information based on the modified scene data and send the modified illumination control information to the lamp control unit 220 (S1040). Next, the lamp control unit 220 may output an illumination control signal corresponding to the modified illumination control information to the lamp module 210 (S1050).

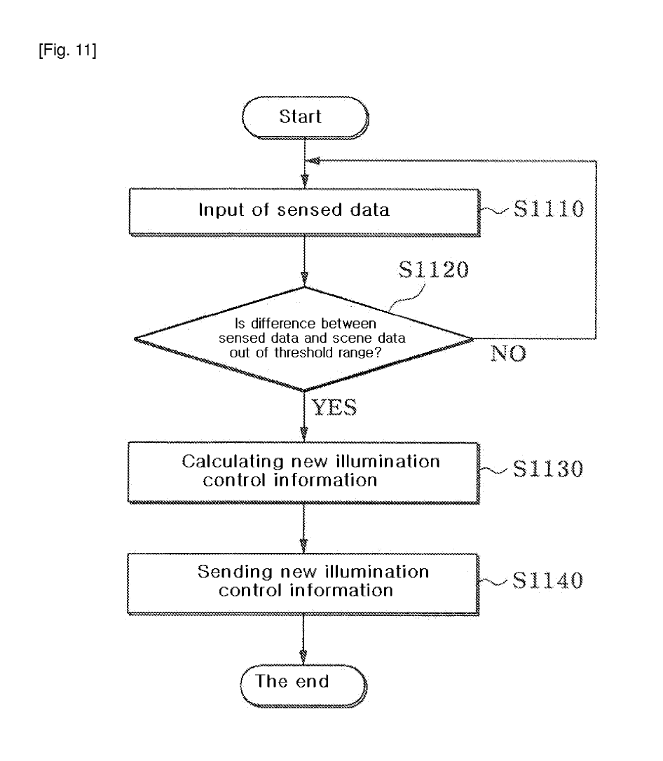

FIG. 11 is a flow chart illustrating a method of correcting illumination control information based on feedback sensed data in accordance with one exemplary embodiment of the present disclosure. At a step (S1110), the sensor module 250 may send sensed data to the control module 240. For example, the sensed data may be a luminance for illumination. At a step (S1120), the control module 240 may determine whether a difference between the sensed data feedback from the sensor module 250 and the scene data is within a predetermined threshold range or not. When the difference between the sensed data feedback from the sensor module 250 and the scene data is within the predetermined threshold range, the sensed data and the scene data may be substantially equal to each other, leading to judgment that the color, brightness and/or color temperature of the lamp module 210 is normally set to comply with the scene data as a control reference of the lamp module. Otherwise, when the difference between the sensed data feedback from the sensor module 250 and the scene data is out of the predetermined threshold range, it may be judged that the color, brightness and/or color temperature of the lamp module 210 is set not to comply with the scene data as a control reference of the lamp module. In this case, the illumination control information for the lamp module 210 should be corrected.

When the difference is out of the predetermined threshold range, the control module may calculate new illumination control information to enable the difference to be within the threshold range (S1130). For example, where the brightness of the real sensed data is lower than that of the scene data, the control module may booster the luminance of the illumination control information. Otherwise, where the brightness of the real sensed data is higher than that of the scene data, the control module may lower the luminance of the illumination control information. In this manner, the illumination control information may be corrected.

At a step (S1140), the control module 240 may send the new illumination control information to the lamp control unit 220 which in turn send to the lamp module 210 a new illumination control signal corresponding to the new illumination control information.

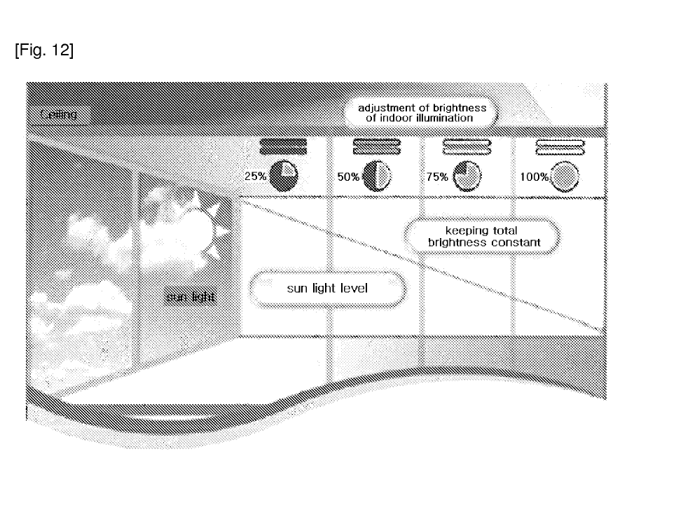

FIG. 12 illustrates an exemplary application of the method of correcting illumination control information in FIG. 11. For example, the illumination control information used to implement the same scene data may be different depending on installation positions of the lamp module 210 such as where the lamp module is disposed nearby a window or at a central region or at a corner. Hence, the illumination control information calculated based on a particular condition (for example, sunny day, central region, or the like) may be corrected based on subsequent feedback about the brightness, color and/or color temperature of the real illumination after control by the previous illumination control information.

It will be apparent to those skilled in the art that various modifications and variations can be made in the present invention without departing from the spirit or scope of the inventions. Thus, it is intended that the present invention covers the modifications and variations of this invention provided they come within the scope of the appended claims and their equivalents.

What is claimed is:

1. A method of controlling a human-friendly illumination, comprising:
determining a displayed object, using a control module, based on at least one data sensed by a sensor module;
receiving, by the control module, from a scene database scene data corresponding to the displayed object;
creating, by the control module, illumination control information based on the scene data and sending the illumination control information to a lamp control unit; and
outputting, by the lamp control unit, an illumination control signal corresponding to the illumination control information to a lamp module.

2. The method of claim 1, wherein the determination comprises:
sensing at least one of a luminance, brightness, color, temperature and humidity using the sensor module to obtain the sensed data; and
retrieving, by the control module, from a display object list the displayed object corresponding to the sensed data.

3. The method of claim 1, wherein the scene data comprises at least one of a brightness, color and color temperature for illumination.

4. The method of claim 1, further comprising:
determining, by the control module, whether the displayed object changes or not based on the sensed data received from the sensor module;
on determination that the displayed object changes, receiving, by the control module, from the scene database new scene data corresponding to the changed displayed object, and updating the scene data based on the new scene data;
updating, by the control module, the illumination control information based on the updated scene data and sending the updated illumination control information to the lamp control unit; and
outputting, by the lamp control unit, an illumination control signal corresponding to the updated illumination control information to the lamp module.

5. The method of claim 1, further comprising:
when a difference between the sensed data feedback from the sensor module and the scene data is out of a threshold range, calculating, by the control module, new illumination control information to enable the difference to be within the threshold range, and sending the new illumination control information to the lamp control unit.

6. The method of claim 1, wherein sending the illumination control information to the lamp control unit comprises modifying, by the control module, a luminance of the scene data so that a power consumption of the lamp module is equal to a target power consumption input via a user interface.

7. The method of claim 1, further comprising:
modifying, by the control module, a color, luminance and/or color temperature of the scene data based on information input via a user interface; and
updating, by the control module, the scene database based on the modified scene data.

8. A method of controlling a human-friendly illumination, comprising:
receiving, by a control module, a displayed object input via a user interface;
retrieving, by the control module, from a scene database scene data corresponding to the displayed object and receiving the retrieved scene data from the database;
creating, by the control module, illumination control information based on the scene data and sending the illumination control information to a lamp control unit; and
outputting, by the lamp control unit, an illumination control signal corresponding to the illumination control information to a lamp module.

9. The method of claim 8, further comprising:
sensing at least one of a luminance, brightness, color, temperature and humidity using a sensor module to obtain the sensed data;
determining, by the control module, from an illumination environment list an illumination environment corresponding to the sensed data and modifying the scene data based on the illumination environment;
modifying, by the control module, the illumination control information based on the modified scene data and sending the modified illumination control information to the lamp control unit; and
outputting, by the lamp control unit, a new illumination control signal corresponding to the modified illumination control information to the lamp module.

10. A system of controlling a human-friendly illumination, comprising:
a lamp module comprising at least one light emitting device;
a lamp control unit to control the lamp module;
a scene database including at least one scene data; and
a control module configured to retrieve from the scene database scene data corresponding to a displayed object and receive the retrieved scene data from the database, and create information to control a luminance of the lamp module based on the scene data and send the information to the lamp control unit.

11. The system of claim 10, wherein the control module comprises a user interface for receiving information about the displayed object.

12. The system of claim 10, further comprising a sensor module to sense at least one of a luminance, brightness, color, temperature and humidity to obtain the sensed data,
wherein the control module is configured to retrieve from a display object list a displayed object corresponding to the sensed data and receive from the scene database scene data corresponding to the retrieved displayed object.

13. The system of claim 10, wherein the control module sends the information to the lamp control unit in a Zigbee communication manner.

14. The system of claim 10, wherein the lamp control unit is configured to measure power consumption of the lamp module and send the measured power consumption to the control module.

15. The system of claim 10, wherein the scene database is created using eXtensible Markup Language (XML).

16. The system of claim 10, wherein the control module comprises:
a central control unit configured to retrieve from the scene database scene data corresponding to a displayed object and receive the retrieved scene data from the database; and
at least one illumination control unit configured to create information to control a luminance of the lamp module based on the scene data and send the information to the lamp control unit.

17. The system of claim 16, wherein the illumination control unit is connected to the central control unit over a communication network including Ethernet.

18. The system of claim 16, wherein the illumination control unit is connected to the central control unit via an input/output interface including USB (universal serial bus).

19. The system of claim 16, wherein the central control unit comprises a user interface configured to display a state of the lamp module controlled by the at least one illumination control unit.
